(19) United States
(12) Patent Application Publication
(10) Pub. No.: US 2007/0292034 A1
(43) Pub. Date: Dec. 20, 2007

(54) Device and method for digitally watermarking an image with GPS data

(76) Inventor: Ira J. Tabankin, Lovettsville, VA (US)

Correspondence Address: MORRISON & FOERSTER LLP, 1650 TYSONS BOULEVARD, SUITE 400, MCLEAN, VA, 22102, US

(21) Appl. No.: 11/713,797

(22) Filed: Mar. 5, 2007

Related U.S. Application Data
(60) Provisional application No. 60/778,364, filed on Mar. 3, 2006.

(51) Int. Cl. G06K 9/36; G06K 9/00; H04N 5/225

(52) U.S. Cl. 382/232; 348/207.99; 382/100

(57) ABSTRACT

A method for digitally watermarking an image or video by replacing the least significant bit of each pixel of the image with GPS data received at the same time the image data was captured so that an image or video can be authenticated by removing the least significant bits, reassembling the bits into a data stream and decoding the data stream.

### FIELD OF THE INVENTION

The present invention relates generally to watermarking a digital image, and more specifically to embedding an image with GPS data.

### BACKGROUND OF THE INVENTION

Watermarking digital images is generally known in the art. Watermarking is a steganographic encoding technique that allows one to hide data within a file in such a way that it is imperceptible to the casual observer. It may be thought of as analogous to invisible ink. Coded images are very good vehicles for this kind of hidden data transfer because of the manner in which their information is stored, and because they are hidden within visual images where very minor color variance would not be noticed.

However, with the help of advanced image editing software, digital images (and video) can be manipulated maliciously. Thus, it is essential to be able to detect image manipulations, especially in the case of authenticating a photo taken by a police officer, for example, which is to be used in a court of law. However, if the watermarks are embedded in only one or a small number of portions of the image, complete authenticity of the image cannot be guaranteed. Further, traditional watermarks can themselves be altered to give the appearance that the image has not been altered.

### SUMMARY OF THE INVENTION

It is an object of the invention to provide a method and apparatus for digitally watermarking an image or a video so that the watermark does not alter the appearance of the image and so that it can be detected whether any pixel of the image has been altered.

It is a further object of the invention to provide a method and apparatus for creating a digital watermark that cannot itself be altered which authenticates the time, date and place that the image was taken.

It is a further object of the invention to provide a portable handheld security device capable of taking digital images and video and embedding a watermark therein to verify the authenticity of the image or video.

Another object of the invention is to provide a method of encoding each frame of a video with a continuous stream of data across each frame, where the data includes a running date and time in which the video was taken.

A further object of the invention is to provide a portable handheld security device having a camera for taking an image and an encoder for encoding the image with GPS data.

### BRIEF DESCRIPTION OF THE DRAWINGS

FIG. 1 is a block diagram illustrating an embodiment of the apparatus of the present invention.

FIG. 2a is a front view of an embodiment of the apparatus of the present invention.

FIG. 2b is a front view of an embodiment of the apparatus of the present invention showing the portability and handheld features of the present invention in use.

FIG. 3 is a diagram illustrating the process of encoding an image with a digital watermark according to an embodiment of the invention.

FIG. 4 is a diagram illustrating how the image data and the GPS data are merged according to an embodiment of the invention.

FIG. 5 is a diagram illustrating how the digital watermark is authenticated according to an embodiment of the invention.

FIG. 6a is a diagram of a camera according to an embodiment of the invention.

FIG. 6b is a diagram of another embodiment of the invention.

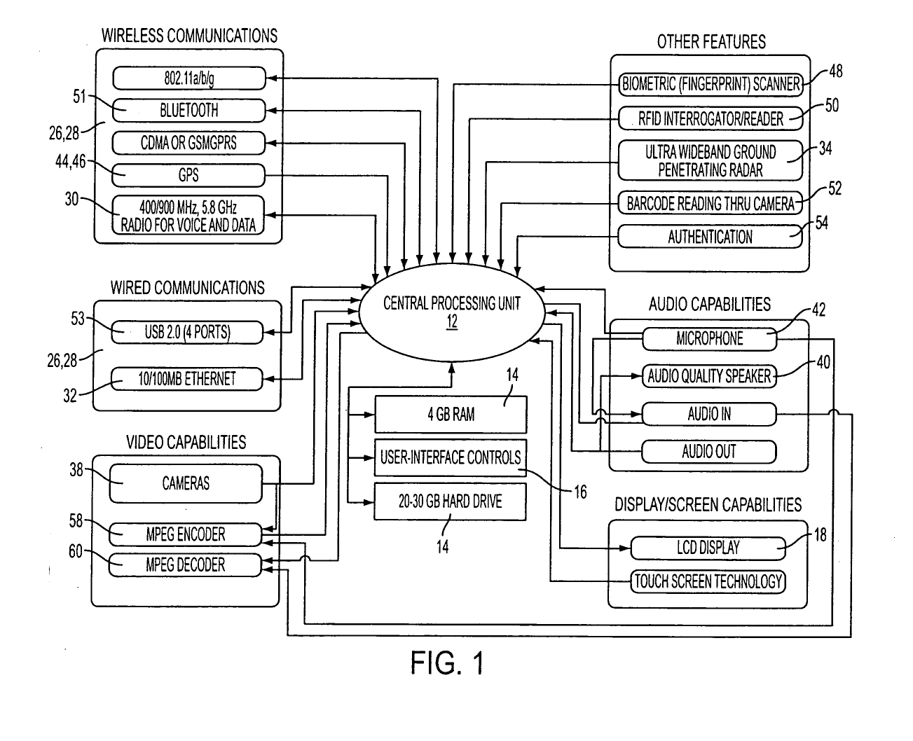

### DETAILED DESCRIPTION OF THE INVENTION

According to an embodiment of the invention, each pixel of an image can be watermarked with GPS data. This may be accomplished by encoding the least significant bit of each pixel of the image with GPS data.

A digital watermark is a piece of information that is hidden in media content in such a way that it is imperceptible to observation but that can be easily detected by a computer. If a watermark is hidden in media content for the purpose of authentication, it must be done in such a way that alteration of the content either destroys the watermark or creates a mismatch between the content and the watermark that can be easily detected.

Watermarking is a process that combines two pieces of information in such a way that they can be independently detected by two different detection processes. One piece of information is the media data, such as music, a photograph or a movie which will be viewed by a human observer. The other piece of information is a watermark, which will be detected by specially designed watermark detector.

Watermarking is possible because human perceptual processes discard significant amounts of data when processing media. According to a preferred embodiment of the invention, a watermark is hidden in an image, either still or in video format, by replacing the least significant bit with a watermark pattern based on GPS data received at the time the image or video was taken. This not only allows the image to be watermarked without altering the image itself, but allows the image to be authenticated with respect to at least date, time and location because the watermark contains the GPS data received at the time the image was taken.

As is well known in the art, an image can be stored as a series of pixels encoded in the Red, Green, Blue (RGB) color space. When using a 24-bit color palette, a 3-byte triplet will represent each pixel, with 8 bits of information for each color plane. When looking at the entire 24-bit color palette, the difference observed between two colors when one flips the value of the least significant bit (or bits) of any of the bytes within the triplet is negligible. Therefore, one could alter the least significant bites from a series of pixels without adversely affecting the image being observed. The same theory applies for altering frames in a video. A CIF frame of video data contains 288 lines, each containing 352 pixels, or a total of 101,376 pixels. In the RGB color space, this would amount to 304,128 bytes of data. If one were to use the least significant bit of each byte for watermarking data, it would take 3 pixels to hide a byte of data, plus one extra bit. This would allow for a theoretical maximum of 33,792 bytes of watermarking data hidden within a single frame of video data. 32 KB is a significant amount of information. If less data is required to be included, more involved methodologies may be used to provide more security. This can be accomplished by encrypting the data before it is inserted, or by using a randomizing algorithm to decide where to insert the data. One of skill in the art will appreciate that there other methods that could be employed.

If there is less data inserted, the overall effect of the changes in the color palette are even less noticeable, even under more intense scrutiny. When observed with a standard image viewer, there should be no discernable differences between images with and without data inserted. Extraction of the information can be performed by an application, either a viewer or an extraction tool, that understands how and where the data were hidden. This extraction tool can identify which bits hold the hidden information, and can extract that data and reassemble it, and perform any decryption necessary to reveal the original data.

In order to ensure that an image can be authenticated, the data used to watermark the image can be GPS data received from a GPS satellite. GPS satellites broadcast three different types of data in the primary navigation signal. The first is the almanac which sends coarse time information along with status information about the satellites. The second is the ephemeris, which contains orbital information that allows the receiver to calculate the position of the satellite. The satellites also broadcast two forms of clock information, the Coarse/Acquisition code, or C/A which is freely available to the public, and the restricted Precise code, or P-code, usually reserved for military applications.

Referring now to the drawings, a portable handheld security device 10 of the present invention has a central processing unit 12 that is ideally a mobile processing unit such as an Intel® Pentium® mobile processor. The security device 10 also includes a memory storage device 14 in communication with the central processing unit 12. The memory storage device 14 ideally includes at least 512 mega bytes (MB) and up to 4 gigabytes (GB) and 20+GB of hard drive space as shown. The security device 10 also includes a power supply 36 preferably comprised of two battery packs in each side handle, for powering the security device 10 and all of its components. The battery packs are ideally rechargeable batteries that can each provide sufficient power to keep the device 10 operational for several hours at a time on a single charge. The battery packs can also preferably be “hot swapped” without shutting the device down.

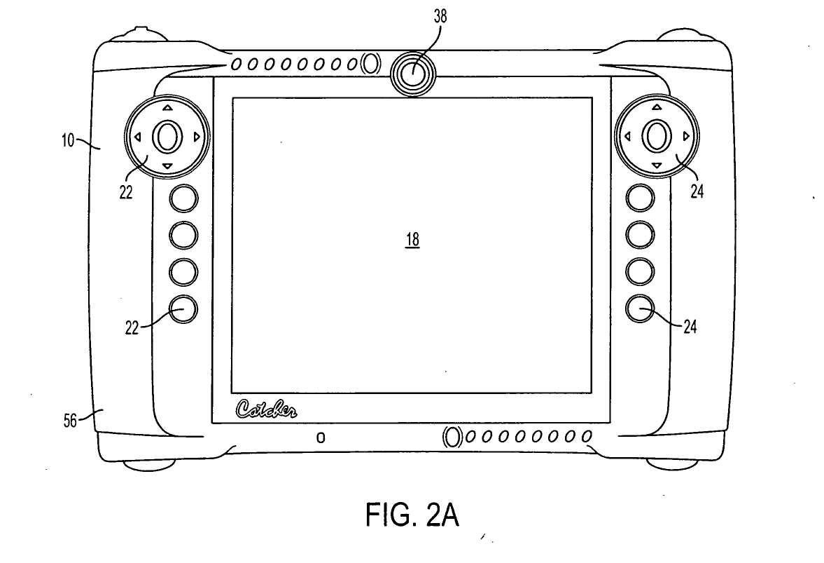

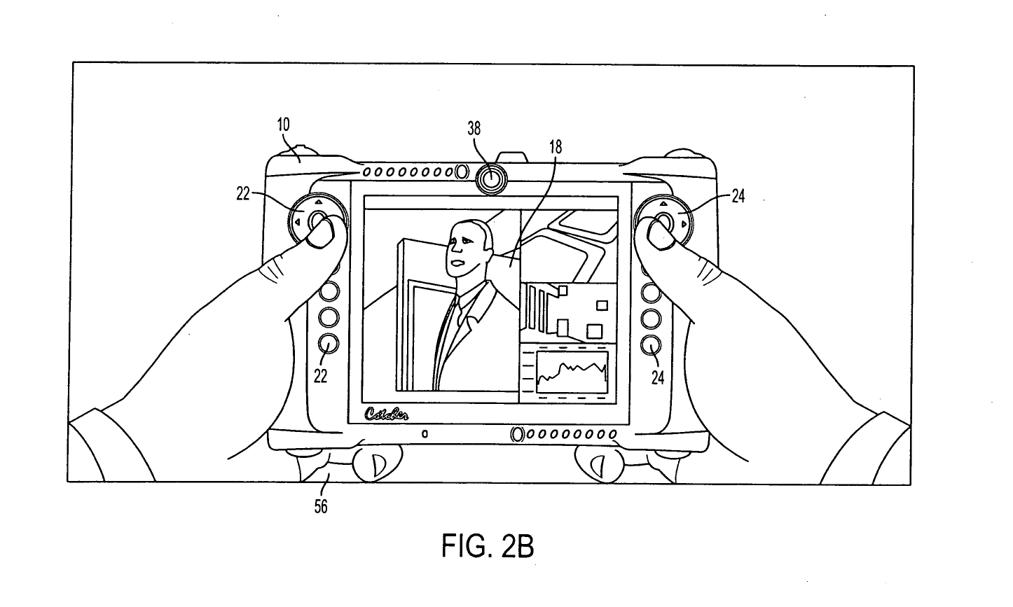

The security device 10 further includes an input device 16. The input device 16 ideally includes user-interface controls and touch screen technology for manipulating the security device 10 and inputting information into the security device 10. The user-interface controls of the input device 16 are preferably auto-ambidextrous in that there are two sets of user-interface controls, as shown in FIGS. 2a and 2b. The first set of user-interface controls 22 and the second set of user-interface controls 24 are selectively operable by users either independently or simultaneously. In other words, the user can select a single set of user-interface controls 22, 24, to accommodate left or right-handed tendencies, and use that set of user-interface controls exclusively and independently of the other set of user-interface controls, or the user can select both sets of user-interface controls 22, 24, if the user is ambidextrous, and use both sets simultaneously. Preferably, the security device 10 can sense which set of user-interface controls 22, 24 has first been touched by a user and make that set of user-interface controls the primary set of user-interface controls, thereby allowing the user, consciously or unconsciously, to select a single set of controls to operate independently based on his or her left or right-handed tendencies. If both sets of controls are touched by a user within a predetermined time period such as 2 seconds, the security device 10 allows both sets of controls 22, 24 to operate simultaneously so that a user can use either hand in the middle of an input or manipulation.

The security device 10 may also include a video display screen 18 in communication with the central processing unit 12. The video display screen is ideally between 5″ and 8.4″ LCD screen that supports touch screen technology. Touch screen technology, or a touch screen display, allows a user to simply touch the video display screen 18 to input information or otherwise manipulate the security device 10. The video display screen 18 also preferably supports direct freehand drawing input, allowing a user to write or draw directly on the video display screen 18 to input information. For example, a user could draw a circle around an image displayed on the video display screen 18, and save the image, including the circle, for later use or distribution to others. Picture-in-picture display is preferably also supported by the video display screen. The video display screen 18 is also ideally readable in any lighting condition, including sunlight, to facilitate both indoor and outdoor use.

At least one camera 38 is also provided in communication with the central processing unit 12 for providing video capability for the security device 10. Ideally, the security device 10 has two digital cameras 38 and can capture both still images and video images up to and including full-motion video images. The full-motion video images ideally are captured at a rate of 30 frames per second, and play back at variable frame rates. Panning, zooming, fast forward, reverse, normal play, and pause features are also preferably supported by the security device 10. At least one of the cameras 38 ideally can operate in infrared light, and at least one of the cameras can ideally operate in normal and low light. Pictures taken in normal, low and infrared light can either be mixed within the same full-motion video image, or the user can switch between the normal, low and infrared light modes as an image is being captured. Each camera ideally has a minimum of 2 mega pixels resolution, and up to 8 hours of full-motion video can ideally be stored in the security device 10. The video capability of the present invention preferably also includes at least a Motion Picture Experts Group (MPEG) encoder and decoder 58, 60.

The security device 10 also includes a transmitting device 26 and a receiving device 28 in communication with the central processing unit 12. The transmitting and receiving devices 26, 28 can ideally securely transmit and receive information using wireless devices 30, such as radio frequency (RF) wireless network cards, or wired devices 32, such as Ethernet cable connections. Many different wireless local area networks (WLANs) can be used with the security device 10, including without limitation 802.11a/b/g, 802.11 “super g,” 802.15.3a, Global System for Mobile Communications and General Packet Radio Service (GSM/GPRS), 3 G, ultra wide band, Bluetooth™, and CDMA 1×. The security device 10 also ideally supports 700 MHz and 4.9 GHz radio for voice and data transmission and receipt. Further, the security device 10, using wireless devices 30, is ideally capable of selecting between available communication network signals, determining which network signal is the best signal at a given time, and automatically switching between the available signals to maintain optimum reception and transmission quality. For example, the security device 10 ideally has middleware that measures the received signal strength of the various network cards and can select the best signal unless the user chooses to “lock in” a particular source. If the security device 10 starts using an RF wireless network card and encounters interference, it can seamlessly switch to another wireless transmission mode without the user knowing a change was made. The security device 10 can also operate whether or not the transmitting and receiving devices 26, 28 are enabled. In other words, the security device 10 can also operate as a stand alone unit. Preferably, when operating as a stand alone unit, the security device 10 continues to look for wireless or wired networks with which it can authenticate. If such a network is located, the security device 10 will preferably exchange pass codes and information with the corresponding network server to transition from stand alone to network operation.

Many other devices and capabilities are also ideally included in the security device 10 of the present invention. Audio capability, including a sound producing device 40, such as speakers, and a sound recording device 42, such as a digital sound recorder including a microphone, is preferably included. A global positioning system 44, a mapping system 46, a biometric scanner 48 including a National Institute of Standards and Technology (NIST) approved fingerprint sensor, a radio frequency identification (RFID) interrogator and reader 50, a Bluetooth™ RF link for headsets and printers 51, bar code reading capability 52, two universal serial bus (USB) ports 53, an Ethernet port and a software authentication system 54 are also preferably provided in the security device 10. In addition, the security device 10 is preferably a complete personal computer (PC) that runs on Microsoft® XP operating system and supports voice, data, video conferencing, email, Microsoft® Office® files, any software that operates under or over Microsoft® XP operating system, forms generation, and document scanning. It should be understood, however, that the security device 10 of the present invention can be configured to run on any operating system including Linux, MacOS, Solaris and Unix.

All of the above-described features of the present invention are ideally contained in a lightweight, handheld housing 56 that is durable enough to meet Military Standard 801F, waterproof, and able to withstand virtually all weather conditions and climates with an operating temperature range of −30 to +50° Celsius. The entire security device 10 is also ideally very lightweight, preferably between 1.5 and 6 pounds including the battery. The handheld, lightweight, wireless security device 10 can easily be carried and operated using one or both hands, as shown in FIG. 2b. The security device 10 can be easily carried and used by personnel in, for example, transportation security, transportation operations, corporate security, education security, first responder organizations, government agencies, the Department of Defense and the Department of Homeland Security.

The security device of the present invention can be used in a number of ways and for a number of purposes. An example of one such purpose relates to capturing images and video which can be easily authenticated.

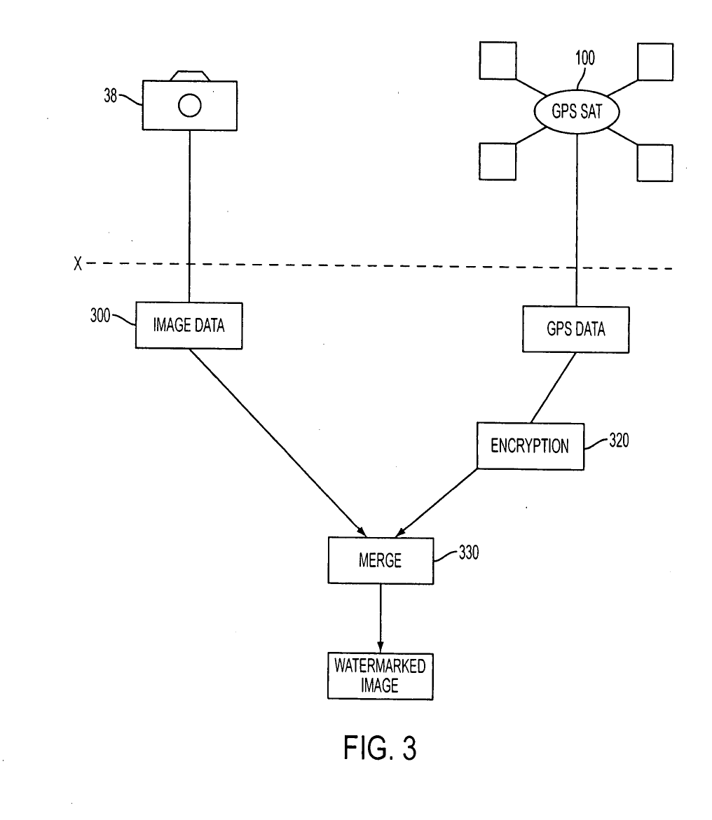

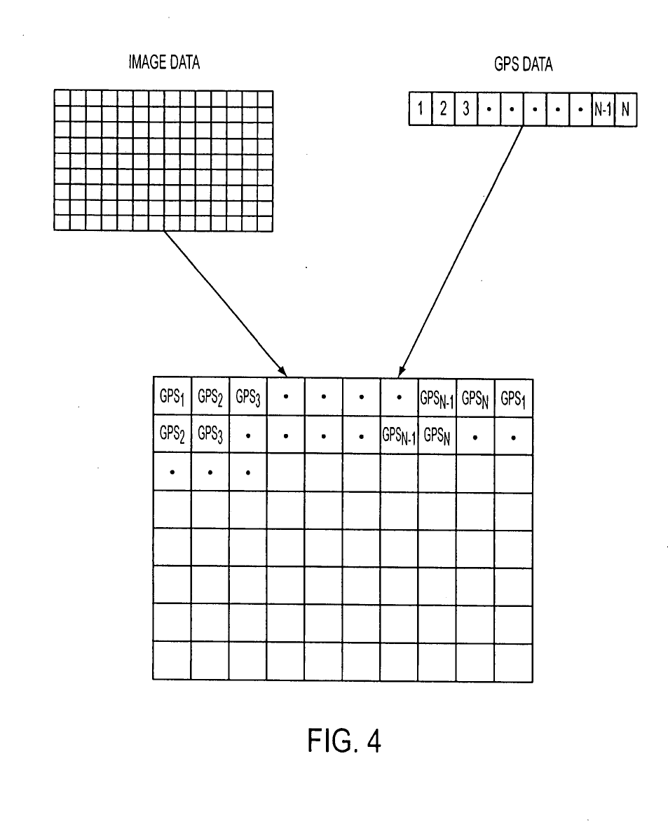

The cameras 38 may be used to digitally capture an image or a stream of images in the form of video. At the same time, the global positioning system (GPS) 44 may receive a signal from the GPS satellites 100. As shown in FIG. 3, the camera is used to take a picture or a video. At a time X, picture data is generated which includes a plurality of pixels depending on the resolution of the image and GPS data is generated which corresponds to a received GPS signal. The GPS data may be encrypted 320 prior to being merged with the image data, or the GPS data may be directly merged with the image data at 330. At 340, the watermarked image is generated. The method of merging the GPS data, either encrypted or unencrypted with the image data will be explained with reference to FIG. 4.

FIG. 4 illustrates a digital image which is divided into a plurality of pixels depending on the resolution of the image. As explained above, each pixel contains 8 bits. The GPS data contains N number of bits of information. When the image data and the GPS data are merged, each least significant bit (LSB) is replaced by a bit of the GPS data, the first bit of the GPS data replaces the LSB of the first pixel. Then, the second bit of the GPS data replaces the LSB of the second pixel, and so on until the Nth bit of the GPS data has been placed in a LSB of a pixel of the image. The GPS data is then repeated in the remaining pixels until all of the pixels of the image have had their LSB's replaced with a bit of the GPS data. It should be understood that the GPS data can be encrypted prior to being merged with the image data. Further, the GPS data can be dispersed throughout the pixels of the image in an encrypted fashion.

It should also be understood that each frame of a video may be watermarked in a similar fashion. Further, one row of each frame of the video, preferably the last row of pixels, may contain an encoded running time clock. In other words, the least significant bits of one of the rows of pixels may contain the time the frame was shot so that if a frame is removed, it will be easily detected by decoding that row of pixels.

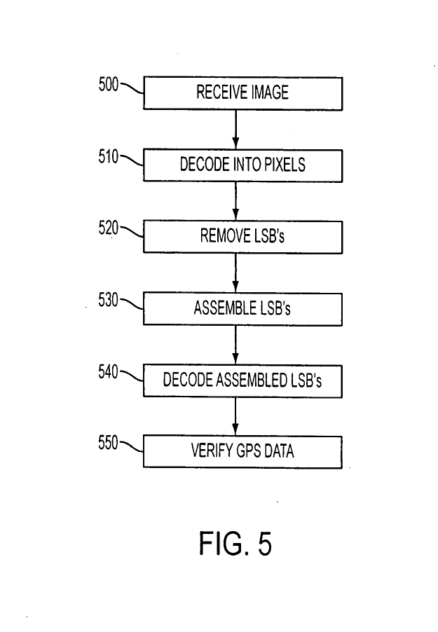

Once an image has been watermarked with GPS data, a video or image may be authenticated as shown in FIG. 5. Authenticating a video or image may be performed by the hand-held security device itself, or a separate device (not shown) which contains decoding software to decode the watermark.

Referring to FIG. 5, at 500 the image or video is received. This may entail transferring the image data to another device, or merely loading the stored image data in the hand-held security device. At 510, the image data is decoded into pixel data, where each pixel of the image is expressed in terms of a “0” or a “1”. At 520, the LSB of each pixel is removed. Each LSB is assembled at 530 and then decoded at 540. Once the LSB's are decoded, the image or video can be authenticated because the original GPS data will be repeated throughout the image. If a portion of the GPS data is missing, it will be evident that a portion of the image was modified and the authentication process will fail.

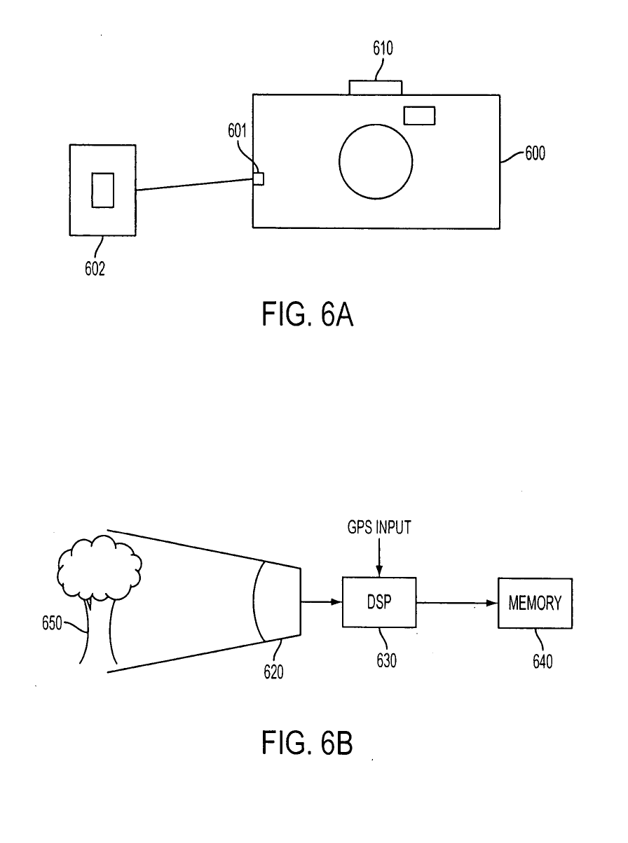

In an alternative embodiment, a stand-alone digital camera may include at least a receiver capable of receiving GPS signals and a processor capable of capturing digital images and embedding a digital watermark containing received GPS data, as discussed above. For example, as shown in FIG. 6a, a camera 600 may include a built in GPS receiver 610 or have a connector 601 that allows a stand-alone GPS unit 602 to be attached to the camera 600. The operation of the process of replacing the LSB of each pixel of an image is the same as discussed above.

FIG. 6b illustrates an example of how the camera 600 having a lens 620 would capture an image 630 and a digital signal processor 630 would process the image with the received GPS input and store the resulting watermarked image in the memory 640.

While the invention has been described with reference to preferred embodiments, it is to be understood that the invention is not intended to be limited to the specific embodiments set forth above. It is recognized that those skilled in the art will appreciate certain substitutions, alterations, modifications, and omissions may be made without parting from the spirit or intent of the invention. Accordingly, the foregoing description is meant to be exemplary only, the invention is to be taken as including all reasonable equivalents to the subject matter of the invention, and should not limit the scope of the invention.

What is claimed is:

1. A method of encoding a watermark in an image, comprising:
capturing image data;
capturing a GPS signal; and
replacing a least significant bit of each pixel of the image data with GPS data.

2. The method of claim 1, wherein the GPS data is encrypted prior to replacing the least significant bit of each pixel.

3. The method of claim 1, wherein the image data may comprise multiple frames of video.

4. The method of claim 3, wherein a time in which the video frame was captured is encoded in the least significant bit of each pixel in a row of pixels in the frame.

5. The method of claim 4, wherein each frame of the video contains an encoded stream of time.

6. The method of claim 1, wherein the GPS signal is converted to bits of data, wherein successive bits of GPS data are placed in successive least significant bits of each pixel of the image data.

7. The method of claim 1, wherein the GPS signal is encrypted and placed bit by bit in random least significant bits of each pixel of the image data according to an encryption scheme.

8. The method of claim 1, wherein the watermark is detected and authenticated by decoding the image data created by replacing the least significant bits of each pixel with the GPS data into pixels, removing the least significant bits of each pixel, assembling the least significant bits together, decoding the assembled least significant bits and verifying the resulting data stream.

9. A device comprising:
a central processing unit;
a memory storage device;
at least one camera capable of capturing digital images;
a receiving device capable of receiving a GPS signal; and
an input device, wherein image data captured by the at least one camera may be digitally watermarked with GPS data.

10. The device of claim 9, wherein the digital watermark is created by replacing a least significant bit of each pixel of the captured image with data corresponding to a received GPS signal which is received at the time the image is captured.

11. The device of claim 10, wherein the GPS data is encrypted prior to being encoded in the image.

12. The device of claim 10, wherein the GPS data is placed in the least significant bits of each pixel according to an encryption scheme.

13. The method of claim 9, wherein the image data may comprise multiple frames of video.

14. The device of claim 13, wherein a time in which the video frame was captured is encoded in the least significant bit of each pixel in a row of pixels in the frame.

15. The device of claim 14, wherein each frame of the video contains an encoded stream of time.

16. The device of claim 9, wherein the watermark is detected and authenticated by decoding the image data created by replacing the least significant bits of each pixel with the GPS data into pixels, removing the least significant bits of each pixel, assembling the least significant bits together, decoding the assembled least significant bits and verifying the resulting data stream.

17. A system for encoding and decoding a digital watermark in an image to verify its authenticity, comprising:
a camera for capturing a digital image;
a receiver for receiving a GPS signal;
a processor for replacing a least significant bit of each pixel of the digital image with a bit of data from the GPS signal; and
a processor for assembling each encoded least significant bit and decoding the assembled data, wherein the processor compares the assembled data with the received GPS signal.

18. The system of claim 17, wherein the digital image comprises a plurality of video frames.

19. The system of claim 18, wherein each frame of the plurality of video frames is further encoded with a stream of data representing a time when the video frame was captured.

20. A camera comprising:
a GPS receiver;
a processor for processing captured image data; and
a memory for storing a processed image, wherein the image data is processed by replacing a least significant bit of each pixel of the image data with GPS data.
